(19) United States
(12) Patent Application Publication
(10) Pub. No.: US 2006/0091344 A1
(43) Pub. Date: May 4, 2006

(54) Variable valve gear

(76) Inventor: Manousos Pattakos, Nikea Piraeus (GR)

Correspondence Address: Pattakos Manousos, Lampraki 356, Nikea Piraeus, 18452, GR

(21) Appl. No.: 10/538,907

(22) PCT Filed: Aug. 12, 2004
(86) PCT No.: PCT/GR04/00043

§ 371 Date: Dec. 15, 2005

(30) Foreign Application Priority Data
Aug. 18, 2003 (GR) 20030100353
Jul. 1, 2004 (GR) 20040100263

(51) Int. Cl. F16K 31/44

(52) U.S. Cl. 251/251

(57) ABSTRACT

The invention provides a variable valve gear particularly for internal combustion engines, in which a control cam (2) of a camshaft (1) acts, by way of a free cam follower, being supported on a rotatable control surface, to a valve (4) to produce an adjustment of the valve stroke. The valve stroke can vary continuously from a maximum value to zero while the valve clearance is held unchanged. In one case the system is nothing more than a roller (6) trapped among a cam lobe, a control shaft (7) and a valve actuator (5).

The invention provides a variable valve gear particularly for internal combustion engines, in which a control cam of a camshaft acts by way of a free cam follower, being supported on a rotatable control surface, to a valve to produce an adjustment of the valve stroke. The valve stroke can vary continuously from a maximum value to zero while the valve clearance is held unchanged.

The closest prior art is the patent application PCT/GR02/00035.

What a variable valve actuation system actually provides is the permanently optimised breathing, and therefore optimised combustion, at all revs and every load: it extends the efficient rev range of an engine at lower and at higher rpm, upgrading the importance of the higher revs.

The proposed variable valve gear comprises fewer and simpler parts. It achieves reliability at higher revs partly because its quickly moving parts are light and strong and partly because the sliding between the cooperating members is changed into rolling, thereby minimizing friction and wear.

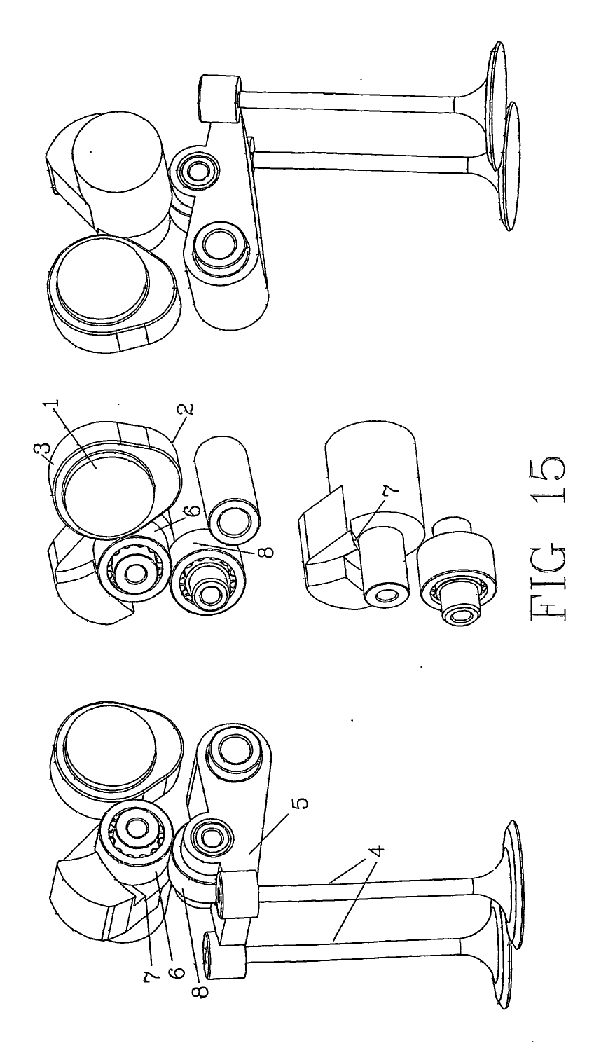

The modification of the present state of the art engine, which provides only two modes of operation with hydraulic control (U.S. Pat. No. 6,470,841) and which holds the world record of power concentration among mass production engines, into an infinite modes engine as shown in FIG. 15, turns out to be a simplification because many parts of the state of the art engine are thrown away, with the remaining parts becoming simpler, lighter and stronger, and because the control can be pure mechanical. The control shafts' rotation has proved in practice easy and needs no assistance: a ‘throttle’ cable coming directly from the gas pedal is enough. Improving the best and simultaneously simplifying it, sounds good.

Despite its infinite modes of operation, it is a more reliable valve train system compared even to the single mode ones. When the engine operates at medium to low revs or at partial load, which happens most of the time and means short valve stroke and weak restoring force due to only slightly compressed valve spring, the loads and the wear and the friction into the valve train system become not just lower than in conventional, but many times lower: the oscillating energy is linearly proportional to both, the restoring force and the valve stroke.

The proposed system can function without drive by wire and without additional supporting systems like variable valve timing, servomotors, special central control unit etc.

The proposed system is easy and cheap in control. The rotation of a control shaft is a more simple and more precise motion compared to the sliding of control members along sliders, used in some of the prior art patents.

In case of a sliding control shaft, like the one described in U.S. Pat. No. 5,373,818, the valve lift and the duration the valve stays open vary necessarily together: small lifts can be only combined to short duration, while long duration can be only combined to high valve lift. At low revs with heavy load an engine needs small lift and long duration, impossible in such mechanisms because they are based on ‘scissor’ action: the valve at short lifts opens only by the tip of the nose of the cam lobe. In the present application the valve duration can be substantially constant, no matter what the valve lift is.

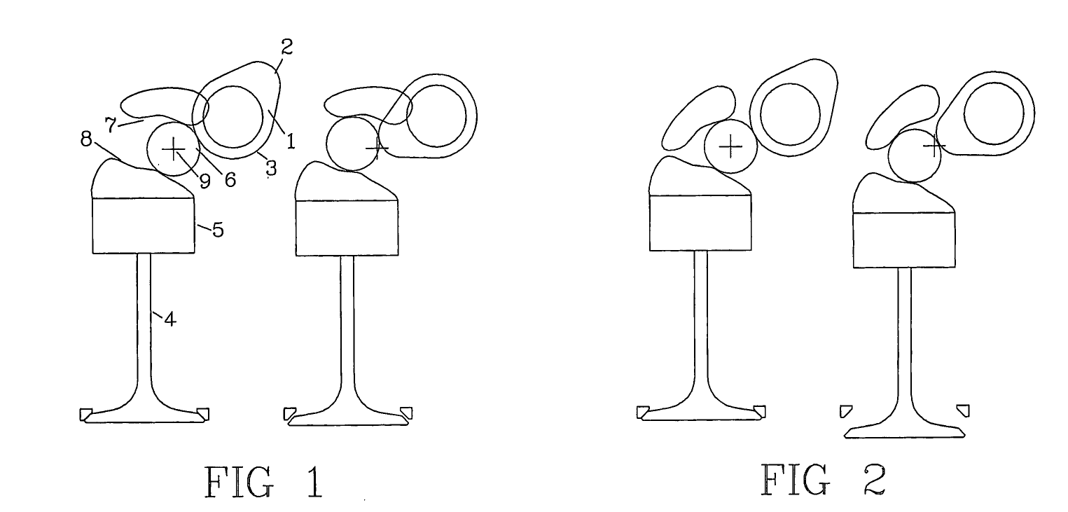

FIGS. 1 to 7 show the basic idea.

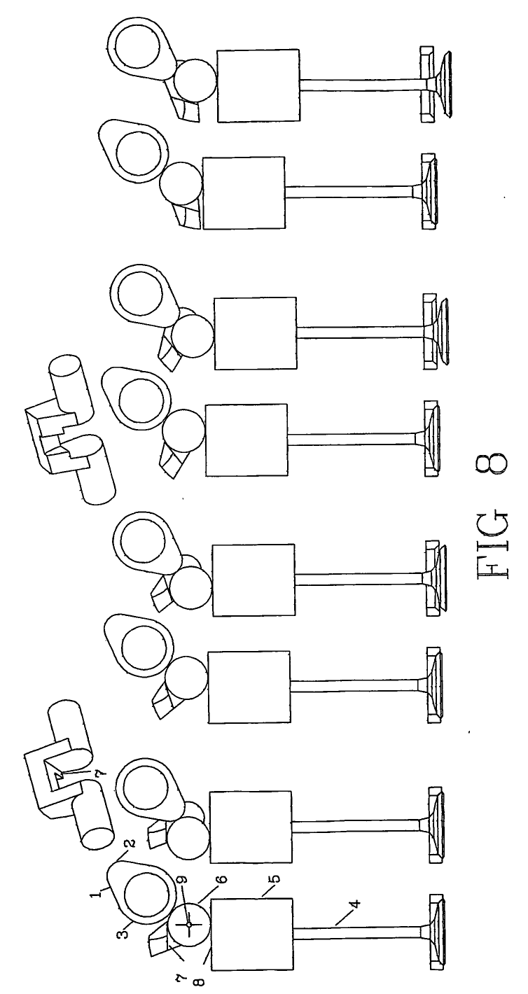

FIGS. 8 to 10 show the case of flat bucket lifter and flat control surface.

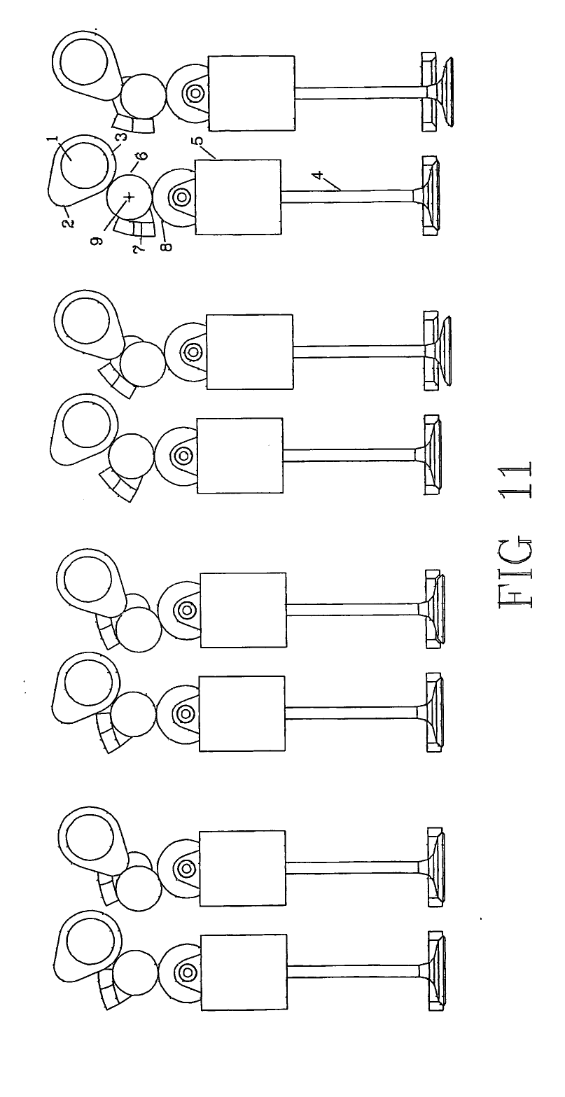

In FIG. 11 it is shown the case of cylindrical control surface.

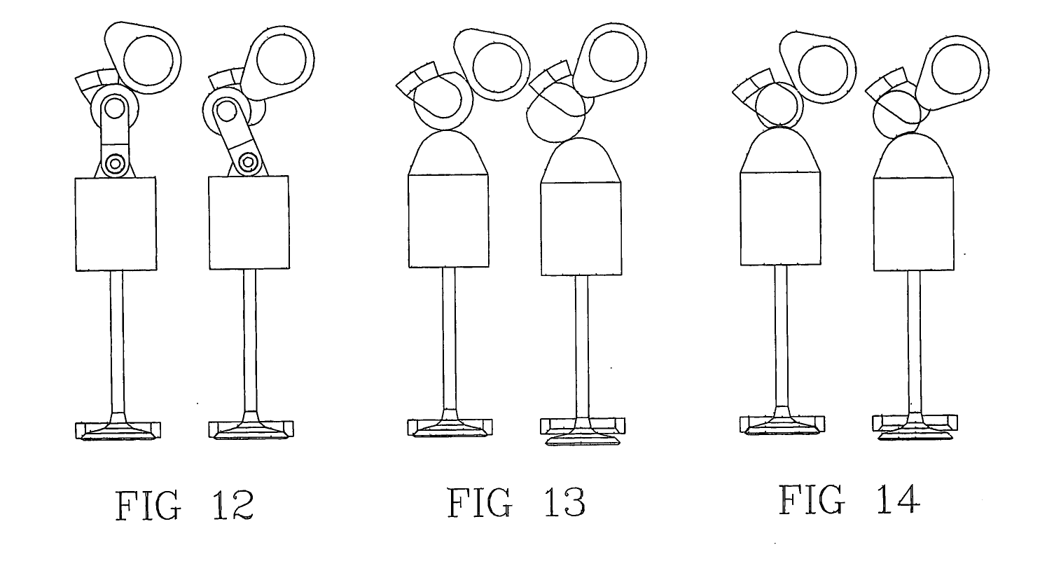

In FIG. 12 a lever, swivelably coupled to the valve actuator, holds the roller, while in

FIGS. 13 and 14 it is the case of partially cylindrical roller.

FIG. 15 shows the application in case of rocker arms.

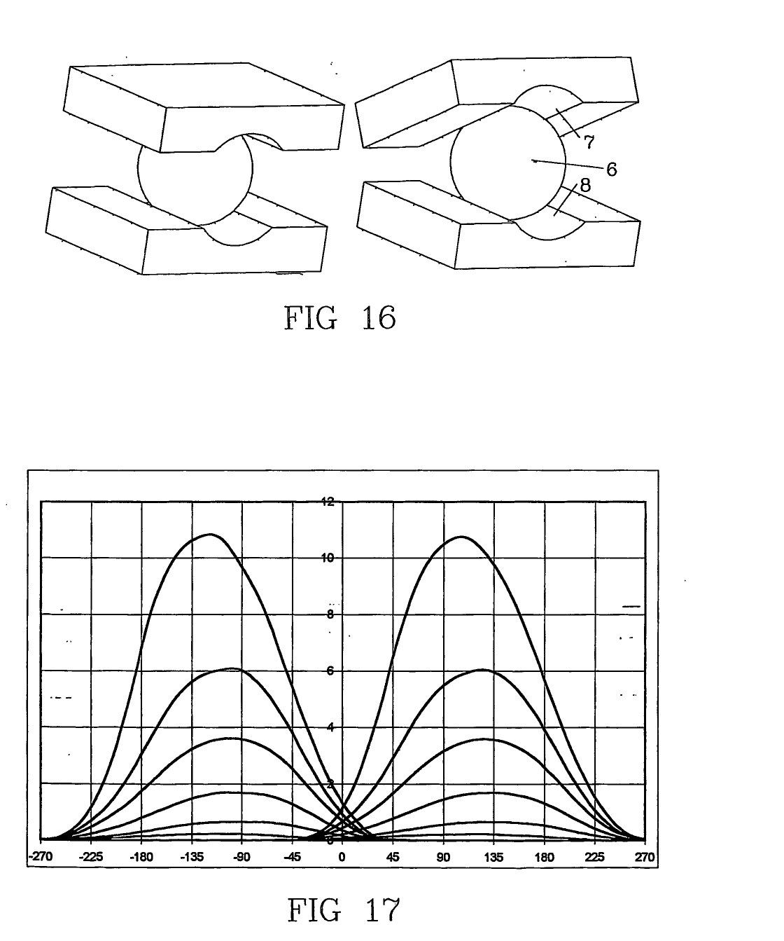

FIG. 16 shows the case of spherical roller and FIG. 17 is the valve stroke versus crank angle plot.

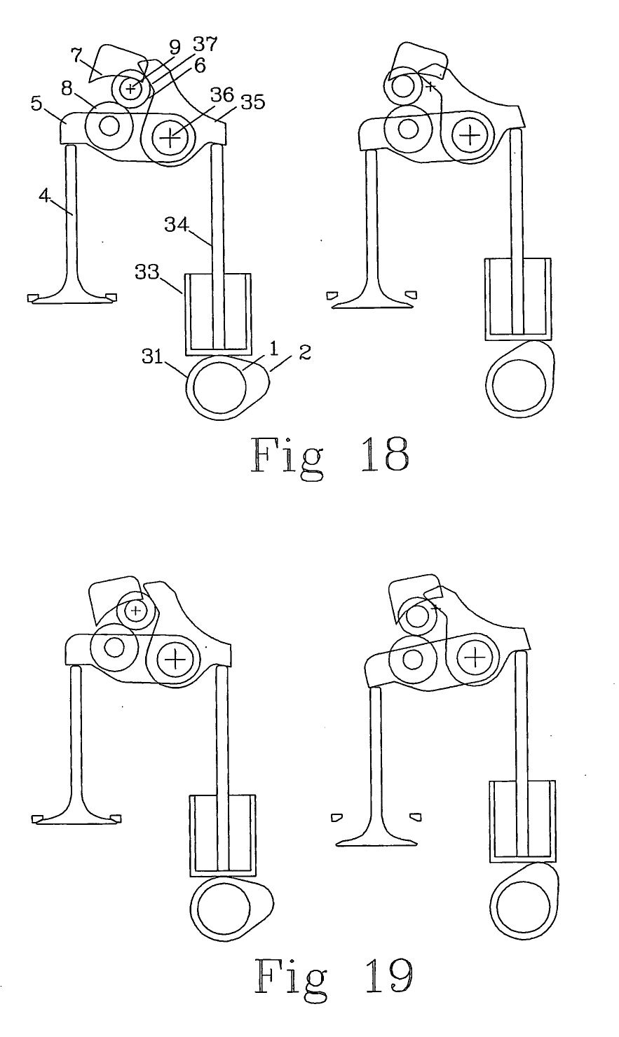

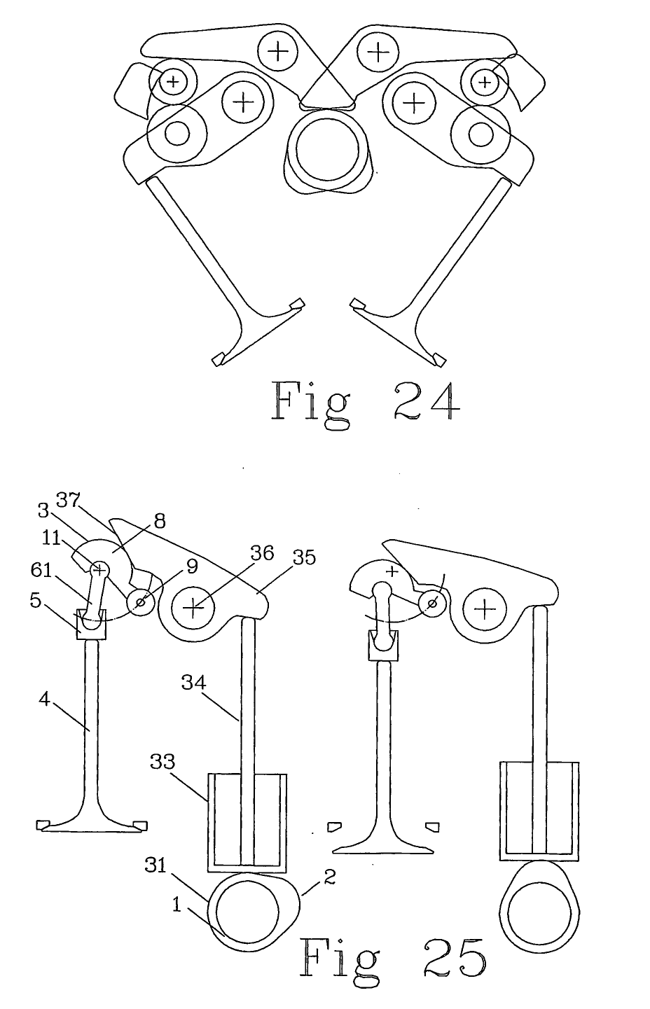

FIGS. 18 to 24 show the case of indirect activation of the roller by the cam lobe.

FIG. 25 shows the application in case of side cam, based on the mechanism of the closest prior art.

FIGS. 1 and 2 show the general form of the mechanism for variable Eft. A cam follower (6) is displaced by a control cam (2) of a camshaft (1), the cam follower (6), thrusting upon, or being supported by, a control surface (7), displaces the valve actuator (5) and the valve (4). The contact of the cam follower (6) with the valve actuator (5) occurs along a contact surface (8) on the valve actuator (5).

To change the valve lift, the control surface (7) is rotatable relatively to the casing, in general. In case that the control surface is rotatable about a constant axis (9) of the casing, to keep the valve clearance constant or acceptably small at all valve lift range, the axis (9) of rotation of the control surface (7) has to substantially coincide with the axis of the cam follower (6) at the rest position, that is when the cam follower (6) is in touch to both, the basic circle (3) of the control cam (2) and the control surface (7). If the axis of the cam follower (6), at the rest position, coincides with the axis (9) of the rotation of the control surface (7), then the clearance remains constant, whatever the profile of the control surface (7) is.

If the axis of the cam follower (6), at rest position, is offset relative the axis (9), then the valve clearance can stay constant only for specific profile forms of the control surface (7). More specifically, if the control surface (7) has an initial part of cylindrical form and its rotation axis (9) coincides to the axis of the cylindrical surface, then the valve clearance can stay constant as long as the cam follower works in this initial cylindrical part of the control surface (7). After the initial cylindrical part of the control surface (7) it may follow another part along which the cam follower displaces the valve actuator, opening the valve.

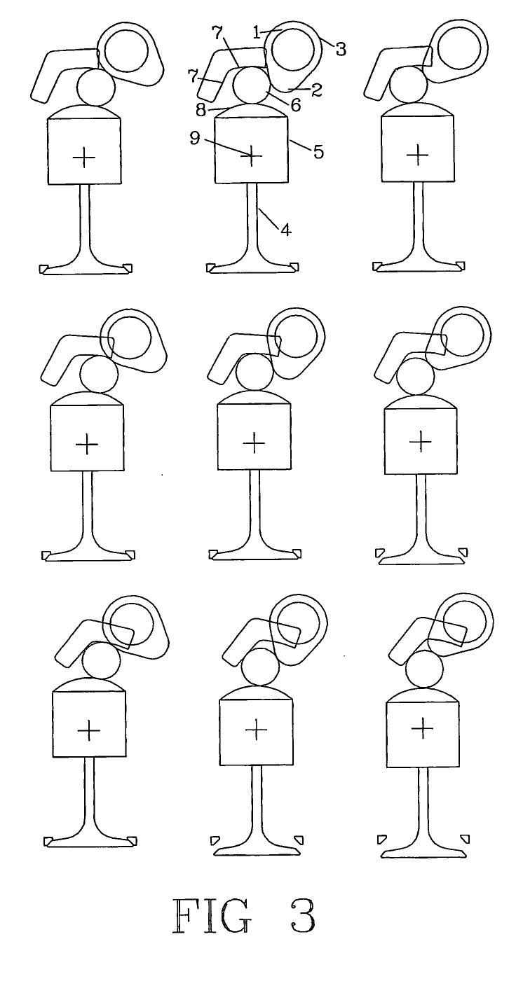

FIG. 3 shows such a system. In the first row the valve stroke is zero because the cam follower moves only along the initial cylindrical part of the control surface (7) for all camshaft angles. In the second row the cam follower is displaced but the valve initially remains closed and only later the cam follower (6) starts displacing the valve for a medium lift. In the third row the control surface is rotated around its axis, at the cross, and the cam follower opens the valve for many degrees and for a long stroke. A system like this provides variable valve lift, variable duration, variable timing and constant valve clearance. It operates similarly to the system described in U.S. Pat. No. 5,373,818, and it is just simpler.

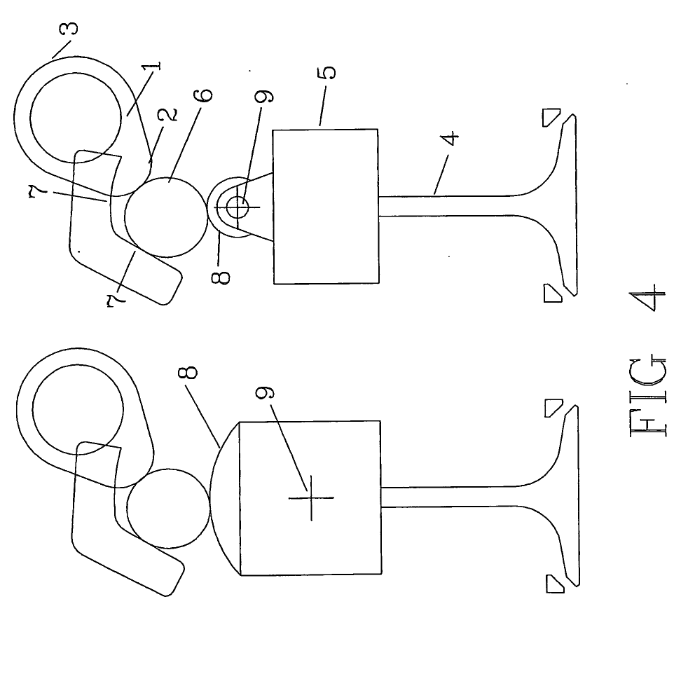

The control surface (7) can be mounted on a rotatable shaft, which is parallel to the camshaft, in order to avoid intermediate members, sliders, the lash between cooperating members, the room for placing all them and their extra mass and cost. In systems like these, the presence of additional variable valve timing system is a necessity, as well as a central control unit for coordinating the subsystems involved. FIG. 4 shows at right the mechanism of FIG. 3 with a roller rotatably mounted on the valve actuator (5), and the contact surface (8) being the periphery of this roller.

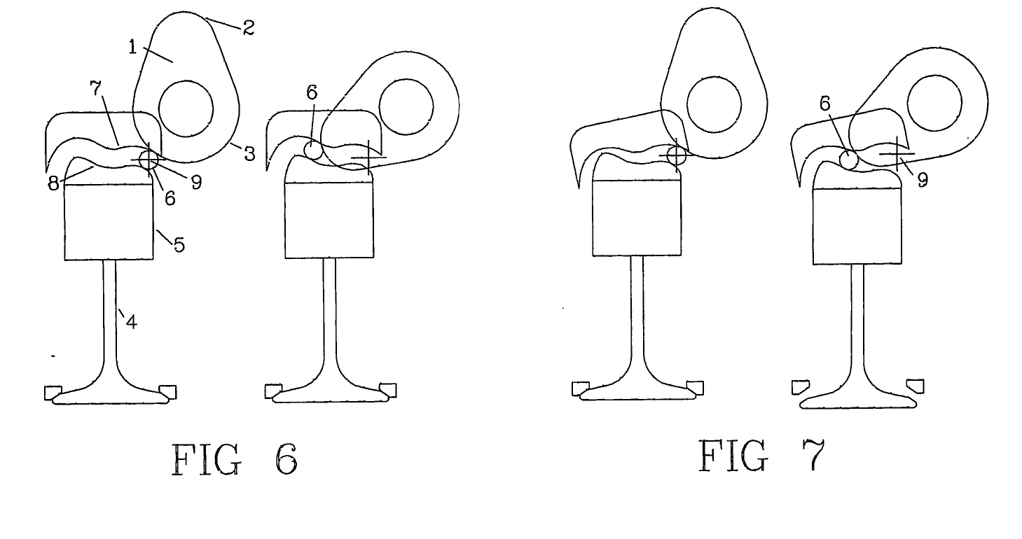

FIGS. 6 and 7 show the system applied on a valve. The control surface (7) is rotatable about the axis at the cross. If the two curves (7) and (8) are ‘parallel’, which means that the cam follower can move in the space between (7) and (8) without displacing the surface (8), then the lift is zero. As the surface (7) is rotated, as shown in the right, the displacement of the cam follower, from the control cam, displaces the surface (8) and the valve actuator (5), opening the valve. By rotating the control surface (7) more, the resulting valve lift increases.

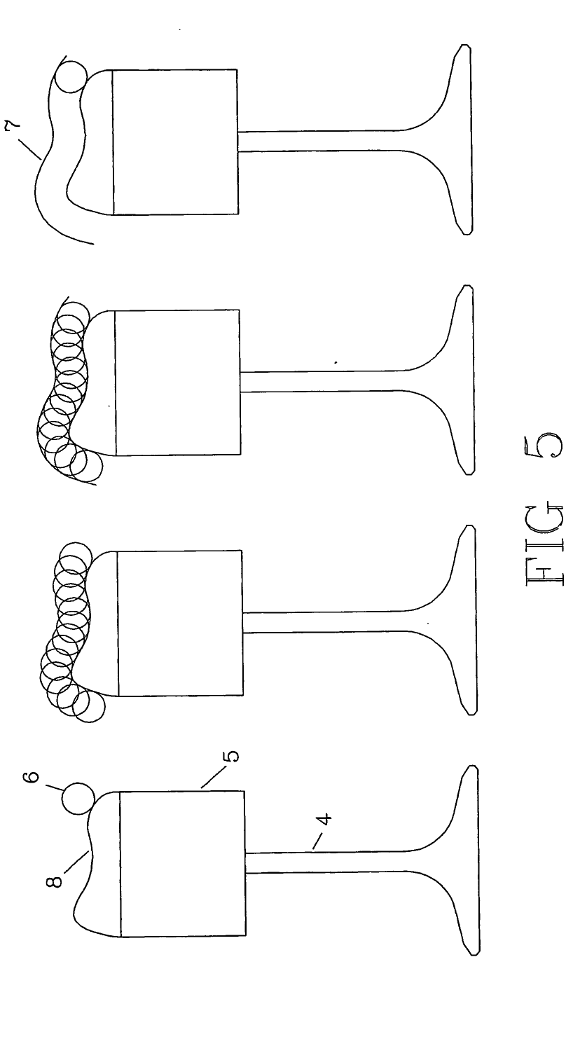

If the zero valve stroke or the small valve strokes are desirable, then there is a way to derive the control surface (7) from the surface (8) of the valve actuator, and vice versa, shown in FIG. 5. In FIG. 5 the contact surface (8) is randomly selected. The cam follower is moved along the surface (8), in touch with surface (8), deriving the corresponding surface (7), as shown in the right. Using spherical instead of cylindrical cam follower, they can be created pairs of control surface/contact surface having ‘proper grooves’ on them, similar to those in ball bearings, as shown in FIG. 16.

It is obvious that there are infinite pairs of control surface (7)/contact surface (8) appropriate to provide continuously variable valve strokes starting from zero, with constant duration, constant timing of valve opening and closing and constant clearance along all valve lift range.

FIG. 8 shows the system in case whre both control surface (7) and contact surface (3) are plane surfaces, i.e. the simplest possible profiles.

When the control surface (7) becomes parallel to the top plane surface (8) of the bucket lifters the lift becomes zero. As the control surface (7) becomes more vertical to the plane defined by axis (9) and camshaft axis, the valve lift increases. The clearance is constant. The valve opening duration is constant. The timing of valve opening and valve closing is constant. FIG. 17 shows the valve displacement, vertical axis, versus crankshaft rotation angle, horizontal axis. The left set of curves are of the exhaust valves, while the right set of curves are for the intake valves. The curves were taken for control surface rotation of 65, 33, 18, 8, 3 and 1 degrees. The valves open and close at substantially constant crankshaft angles, and although the angular overlap remains unchanged, the actual overlap is radically changed along with the maximum valve lift. From the working medium point of view the actual overlap depends on how much time the intake and the exhaust stay both opened and on how easily exhaust and intake communicate during this time.

The constant duration and timing make the control of the engine easy, with the rotation of the control surface (7) as the basic variable. The control surface (7), thanks to the action of the normal valve springs, returns to its ‘idling’ position when it is left free. In the simplest case, the accelerator pedal can rotate, by a mere string, the control surface (7) increasing the valve lift, so permitting more mixture to enter the cylinder, which is similar control with the rotation of the throttle valve of the conventional spark ignition engines.

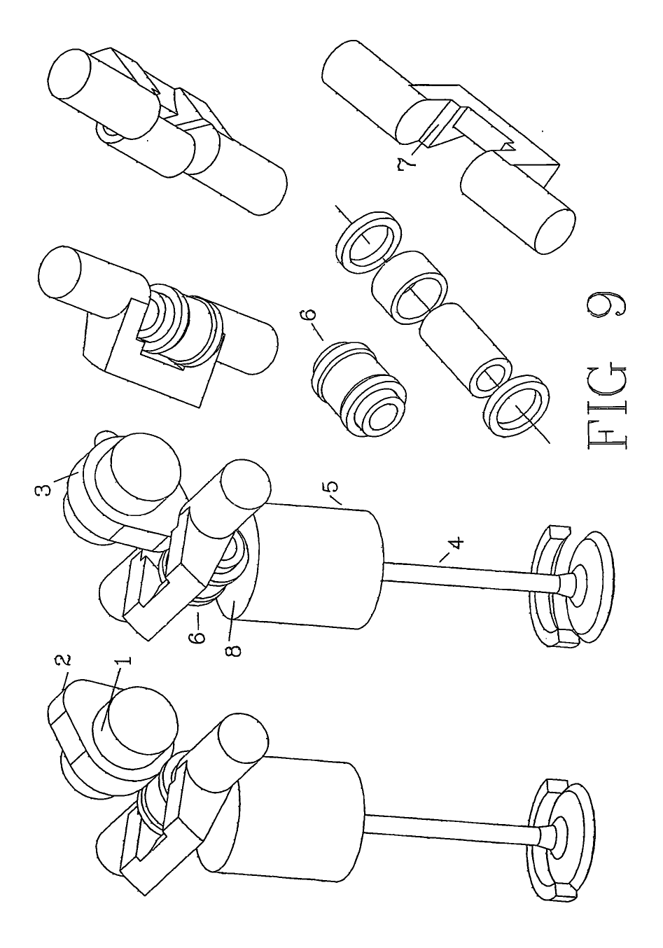

To minimize the friction, instead of a roller cam follower rolling or sliding on the cam lobe (2) and on the control surface (7) and on the contact surface (8), a combined roller cam follower can be used as the one shown in FIG. 9. The central pin rolls on a plane surface machined on the control shaft, the middle ring rolls on the control cam and the two side rings rolls on the top surface of the bucket lifter.

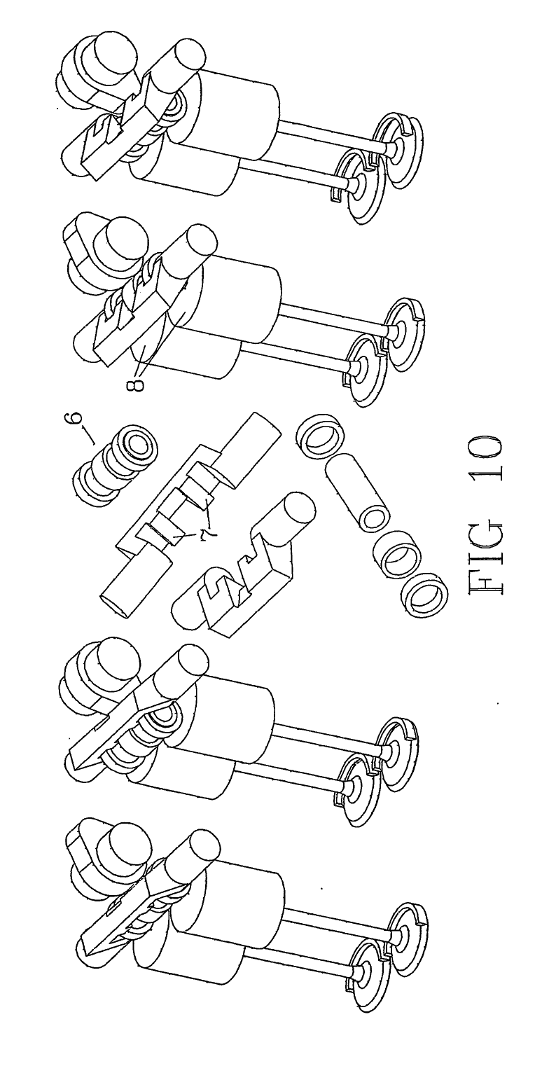

FIG. 10 shows the case of common cam follower activating a pair of valves. The control surface is plane, the internal pin of the cam follower rolls on the flat control surface mounted on the control shaft, the middle ring rolls on the control cam, and each one of the side rings rolling on a plane top valve actuator activates one valve. At left it is for short valve stroke and at the right for long valve stroke. In the middle it is shown the control shaft from different points of view and the cam follower exploded.

Besides the simple and lightweight construction, the system is short and comprises few components. The rollers are easily found in the market while the control shafts are easier to make with plane control surfaces.

FIGS. 11 and 15 show another embodiment of the system described, with cylindrical control surface (7). In FIG. 11 the cam follower (6) rolls or slides on the control cam, on the control surface (7) and on the contact surface (8) which is the periphery of a roller. For lower friction the roller (6), as shown in FIG. 15, has an internal pin rolling on the cylindrical control surface (7) while the middle ring rolls on the control cam and the two side rings roll on the roller (8) of the rocker arm.

In the previous analysis the cam follower is actually free. This means that there is no need for rocker arms or levers to hold it in place. The cam follower is trapped among the control cam, the control surface and the contact surface. The cam follower is kept in place axially by appropriate cross section form of the control shaft, of the contact surface and of the camshaft.

If the control surface (7) or the contact surface (8) are of cylindrical form, which actually means they keep the cam follower in a constant distance from an axis, to keep the cam follower in a constant distance from an axis, the cylindrical surface can be substituted by a proper lever swiveling about an axis as shown in FIG. 12.

If the control surface (7) or the contact surface (8) are of constant curvature, the cam follower can be only partially cylindrical or spherical, as shown in FIGS. 13 and 14.

FIG. 15 shows the application of the mechanism of FIG. 11 in the case of a rocker arm valve actuator driving a pair of valves. The internal pin of the cam follower rolls on a cylindrical surface machined on the control shaft, while the external ring of the cam follower rolls on the control cam and rolls also on a roller rotatably mounted on the rocker arm to lower the friction.

At zero valve lift, used to deactivate some valves or cylinders, and at short valve strokes a spring mechanism to hold the cam follower in contact to the control cam can be added.

For securing the cam follower in position, especially at extreme positions, the control surface or the contact surface or the casing can be properly modified to act as stopper.

In case of immovable control shaft, that is in case the control shaft is replaced by a thrust wall, and despite the resulting unique mode of operation, the valve train system is actually improved: if the control shaft at the right side of FIG. 8 is kept immovable, the bucket lifter valve actuator can be minimized in side, weight and strength because it never comes in contact to the cam lobe, and because the thrust loads are taken before it.

In the side camshaft arrangement shown in FIG. 18 and 19, the cam lobe displaces the bucket lifter and the pushrod. The pushrod, in turn, displaces a first rocker arm. The first rocker arm displaces a free roller which in turn displaces a second rocker arm which finally displaces the valve. Depending on the rotation angle of a control shaft the stroke of the valve varies continuously, while the valve clearance remains constant.

The mechanism operates as the previously described mechanisms with the difference that the cam lobe does not displaces directly the free roller but indirectly, through a linkage, a lever, etc.

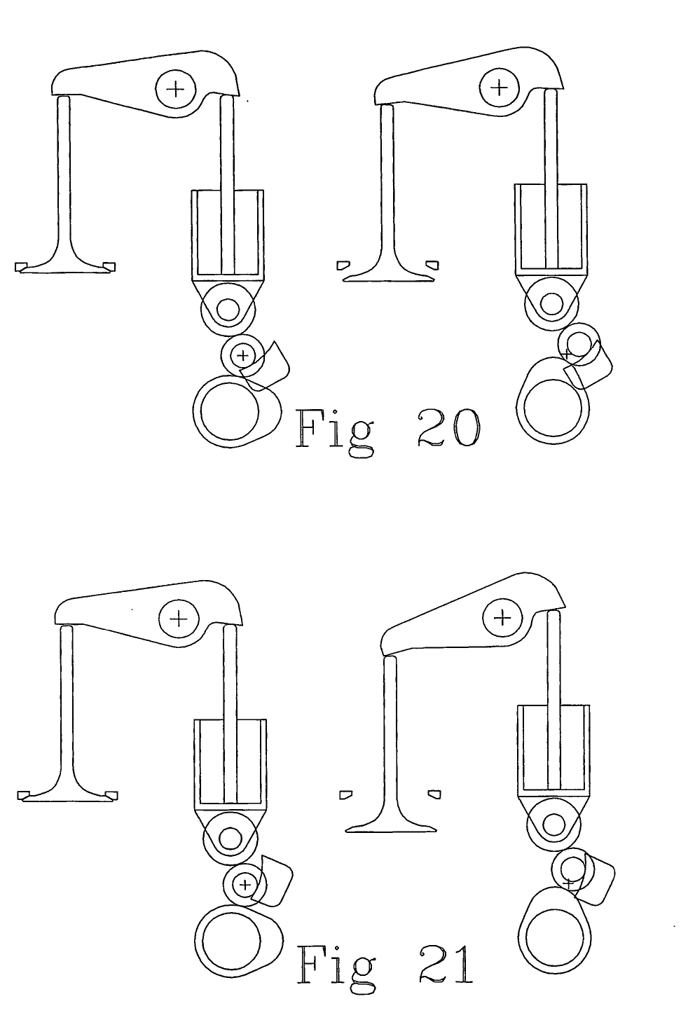

Compared to the side cam shaft arrangement shown in FIG. 20 and 21, the arrangement of FIG. 18 and 19 is preferable, as explained in the following.

It initially conveys on the cylinder head, i.e. close to the valve, the complete or ‘full amplitude’ cam lobe action as a wide oscillation of the first rocker arm and only then the mechanism with the free roller modifies the cam lobe action into a long or shorter stroke of the valve, depending on the angular position of the control shaft. On the contrary, the arrangement of FIG. 20 and 21, with the free roller directly activated by the cam lobe, cannot be so precise at short lifts, exactly where the precision is required, because the in-between joints and the elasticity of the members involved to convey the cam lobe action to the cylinder head, cannot transfer accurately short lifts to the valve, for instance lifts of 0.2 to 0.3 mm.

It is also a matter of accessibility and of lack of space. Upgrading a side cam engine, for instance a Vee eight, according FIG. 18 an 19, all modifications concern exclusively the cylinder head, where there is easy access, plenty of space to install the new components and some ready supporting means, like pivot shaft, for the rocker arms and the control shaft. On the contrary the upgrade of a side cam engine according FIGS. 20 and 21 needs serious modification of the block, while the space and the accessibility in the camshaft area are not the desirable.

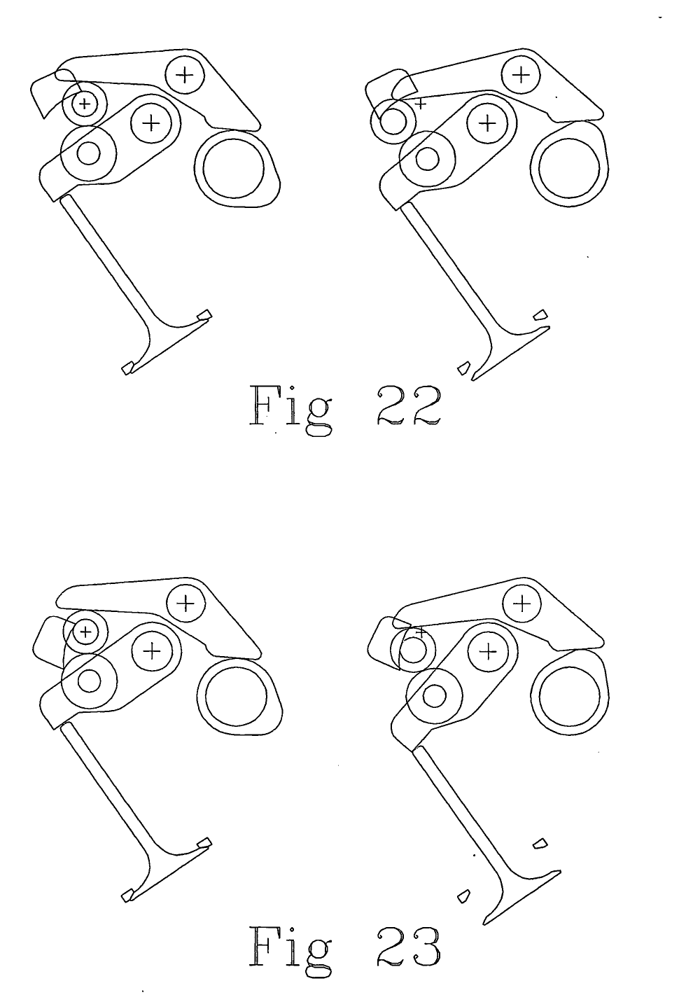

As shown in FIG. 22 to 24 the mechanism can be applied in overhead camshaft arrangements too, offering more freedom to the designer, for instance the use of common overhead camshaft for intake and exhaust.

All arrangements proposed in the closest prior art can be modified similarly: in the present invention, the member mentioned in the closest prior art as the cam follower is displaced not directly by the cam lobe but indirectly through a lever or a linkage, as in FIG. 25, where the version with the swivelably coupled levers of the closest prior art is applied on a side cam engine.

The system is applicable in every poppet valve engine.

Although the invention has been described and illustrated in detail, it is to be clearly understood that the same is by way of illustration and example, and is not to be taken by way of limitation. The spirit and scope of the present invention are to be limited only by the terms of the appended claims.

1. A variable valve gear comprising at least:
a casing; a cam shaft (1);
a control cam (2) mounted on said cam shaft (1);
a valve (4);
a valve actuator (S) for displacing said valve (4);
a roller (6);
a control shaft (7) rotatable about an axis (9) of said casing;
characterized in that:
the roller couples the control cam and the valve actuator and the control shaft, the control cam displaces the roller, and the roller, supported on the control shaft, displaces the valve actuator and the valve at a variable stroke depending on the angular displacement of the control shaft,
thereby a simple, light, compact, precise, low friction, capable for high revs, easy to adjust and easy to control continuously variable valve lift system, with acceptably small valve clearance for all available valve lifts, can result.

2. As in claim 1 characterized in that:
the roller comprises pins and rings in order to reduce or eliminate the sling of the roller on the members it couples.

3. As in claim 1 characterized in that:
the roller is cylindrical or spherical or barrel shaped or in general is a solid of revolution or comprises solids of revolution.

4. As in claim 1 characterized in that:
the roller is a free roller trapped among the control cam, the control shaft and the valve actuator.

5. As in claim 1 characterized in that:
the roller is only partially cylindrical or it is a fraction of a solid of revolution.

6. As in claim 1 characterized in that:
the roller is in direct contact to the control cam and to the control shaft and to the valve actuator.

7. As in claim 1 characterized in that:
the roller is a roller bearing rolling directly on some or all of the members it couples.

8. As in claim 1 characterized in that:
the axis of rotation of the control shaft and the axis of the roller are substantially offset to each other when, with the valve closed, the roller is in touch to the basic circle of the control cam, the roller is supported along a surface of the control shaft which comprises a lost motion initial part followed by an activation part, said lost motion initial part is substantially a surface of revolution with axis substantially coinciding the axis of rotation of the control shaft,
thereby a variable lift/variable duration/variable timing system results.

9. As in claim 1 characterized in that:
the rotation axis of the control shaft substantially coincides to the axis of the roller when, with the valve closed, the roller is in touch to the basic circle of the control cam,
thereby a variable valve lift with substantially constant duration, timing and clearance can result.

10. As in claim 1 characterized in that:
there is a lever swivelably coupled, at one end, to the valve actuator, and the lever holds, at its other end, the roller.

11. As in claim 1 characterized in that:
the profile of the contact surface between the control shaft and the roller, and the profile of the contact surface between the valve actuator and the roller are properly selected to provide the desirable range of valve lifts with acceptably small valve clearance.

12. As in claim 1 characterized in that:
the profile of the contact surface between the control shaft and the roller, and the profile of the contact surface between the valve actuator and the roller are properly selected to provide valve lifts from substantially zero to a maximum, with acceptably small valve clearance,
thereby a throttless system can result, as well as a system for deactivating some cylinders.

13. As in claim 1 characterized in that:
the profile of the contact surface between the control shaft and the roller, and the profile of the contact surface between the valve actuator and the roller are plane or cylindrical.

14. As in claim 1 characterized in that
the roller is displaced by said control cam indirectly, through a linkage,
thereby a high precision system can result, suitable for arrangements like the side cam engines.

15. A variable valve gear, comprising:
a cam shaft (1);
a control cam (2) mounted on said cam shaft (1);
a cam follower (33);
a valve (4);
a valve displacing device (5) for displacing said valve (4);
a valve lever (61) swivellably coupled to said valve displacing device (5);
a control lever (8) rotatable about an axis (9) and swivelably coupled to said valve lever (61) at a swivel joint (11);
an adjusting device for displacing said axis (9) along a path; the stroke of said valve (4) is variable according the displacement of said axis (9) along said path;
characterized in that:
the swivel joint (11) between said valve lever (61) and said control lever (8) is displaced by said control cam (2) indirectly through a linkage;
thereby a high precision system can result, especially suitable for arrangements like the side cam engines.
